(19) United States
(12) Patent Application Publication
(10) Pub. No.: US 2013/0013211 A1
(43) Pub. Date: Jan. 10, 2013

(54) CNT FIBER BASED IMPEDANCE SPECTROSCOPY FOR CHARACTERIZING DOWNHOLE FLUIDS

(75) Inventor: Sunil Kumar, Celle (DE)

(73) Assignee: BAKER HUGHES INCORPORATED, Houston, TX (US)

(21) Appl. No.: 13/536,658

(22) Filed: Jun. 28, 2012

Related U.S. Application Data
(60) Provisional application No. 61/505,651, filed on Jul. 8, 2011.

(51) Int. Cl. G01V 3/38; G01V 9/00; G01V 3/26; G06F 19/00; G01V 3/24; G01V 9/02; B82Y 15/00

(52) U.S. Cl. 702/7; 977/954

(57) ABSTRACT

The present disclosure relates to an apparatus and method for estimating a parameter of interest of a downhole fluid using a fluid analysis module. The fluid analysis module may include: at least one nano element and a processor configured to estimate an impedance of the at least one nano element. The fluid analysis module may include an AC power supply configured to supply electrical signals at a plurality of frequencies through the at least one nano element. The method may include bringing the downhole fluid into contact with the at least one nano element; supplying electrical signals through the at least one nano element at a plurality of frequencies; generating impedance information for the at least one nano element in response to the electrical signals; and estimating the at least one parameter of interest using the impedance information.

### CROSS REFERENCE TO RELATED APPLICATIONS

This applications claims priority from U.S. Patent Application Ser. No. 61/505,651 filed Jul. 8, 2011, the disclosure the disclosure of which is incorporated herein by reference in its entirety.

### FIELD OF THE DISCLOSURE

This disclosure generally relates to estimating at least one parameter of a downhole fluid.

### BACKGROUND OF THE DISCLOSURE

Fluid evaluation techniques are well known. Broadly speaking, analysis of fluids may provide valuable data indicative of formation and wellbore parameters. Many fluids, such as formation fluids, production fluids, and drilling fluids, contain a large number of components with a complex composition.

The complex composition of such fluids may be sensitive to changes in the environment, e.g., pressure changes, temperature changes, contamination, etc. Thus, retrieval of a sample may cause unwanted separation or precipitation within the fluid. Additionally, some components of the fluid may change state (gas to liquid, or liquid to solid) when removed to surface conditions. If precipitation or separation occurs, it may not be possible to restore the original composition of the fluid.

### SUMMARY OF THE DISCLOSURE

In aspects, this disclosure generally relates to analysis of downhole fluids. More specifically, this disclosure relates to analysis of fluids using a response of at least one nano element to electrical signals at a plurality of frequencies.

One embodiment according to the present disclosure includes a method of estimating a parameter of interest of a downhole fluid, the method comprising: estimating the parameter of interest based on an impedance of at least one nano element using a processor, the at least one nano element being in contact with the downhole fluid and responsive to a plurality of frequencies.

Another embodiment according to the present disclosure includes an apparatus for estimating at least one parameter of a downhole fluid, the apparatus comprising: at least one nano element configured to be in contact with the downhole fluid; and a processor configured to estimate the impedance of the at least one nano element over a plurality of frequencies.

Examples of certain features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a fluid analysis module deployed in a borehole along a wireline according to one embodiment of the present disclosure;

FIG. 2 shows a schematic of a fluid analysis module according to one embodiment of the present disclosure;

FIG. 3 shows a schematic of a fluid analysis module according to another embodiment of the present disclosure;

FIG. 4 shows a schematic of a fluid analysis module according to another embodiment of the present disclosure;

FIG. 5 shows a schematic of a fluid analysis module according to another embodiment of the present disclosure;

FIG. 6 shows a schematic of a fluid analysis module with a probe extending into an earth formation according to another embodiment of the present disclosure;

FIG. 7 shows a flow chart of a method for analyzing a fluid using a fluid analysis module according to one embodiment of the present disclosure; and

FIG. 8 shows a graph of a real part of complex impedance varying with frequency for a fluid as estimated in one embodiment using a fluid analysis module according to one embodiment of the present disclosure.

### DETAILED DESCRIPTION

This disclosure generally relates to analysis of fluids. In one aspect, this disclosure relates to analysis of fluids using an estimated impedance over a range of frequencies when an AC voltage is applied to a nano element in contact with a downhole fluid. Herein, the term “nano element” relates to an object that is less than one micrometer along at least one dimension. Nano elements may include, but are not limited to, nano particles, nanotubes, nano fibers, nano thin films, and nano wires.

Nano elements may have large surface area to volume ratios, which may enable the nano element composed of a material with a mass and a volume to have a much larger surface area than another element of the identical material with an identical mass that has its smallest dimension in the micrometer range or larger. The larger surface area means that the nano element may have more contact with the molecules of a fluid sample through adsorption than larger elements.

Some nano elements may be composed of materials that allow the conduction of electricity. The large number of particles adsorbed to the surface of the nano element may alter the electrical conductivity of the nano element, such as altering the impedance of the nano element. In the science of impedance spectroscopy, a nano element may be scanned over a range of frequencies in order to determine if the spectrum impedance (complex resistance) changes when the nano element is in contact with another substance, such as a fluid. Thus, when an AC voltage is applied to the nano element over a plurality of frequencies, the nano element may exhibit a signature impedance-frequency relationship. The plurality of frequencies may include, but is not limited to, a range of about 1 kHz to about 100 MHz. When the nano element is placed in contact with a fluid, the impedance-frequency relationship may change, and the change may be specific to at least one parameter of the fluid. Thus, parameters of the fluid may be estimated from the change in impedance characteristics of the nano element. Several non-limiting embodiments of an apparatus configured to use the proposed technique are described below.

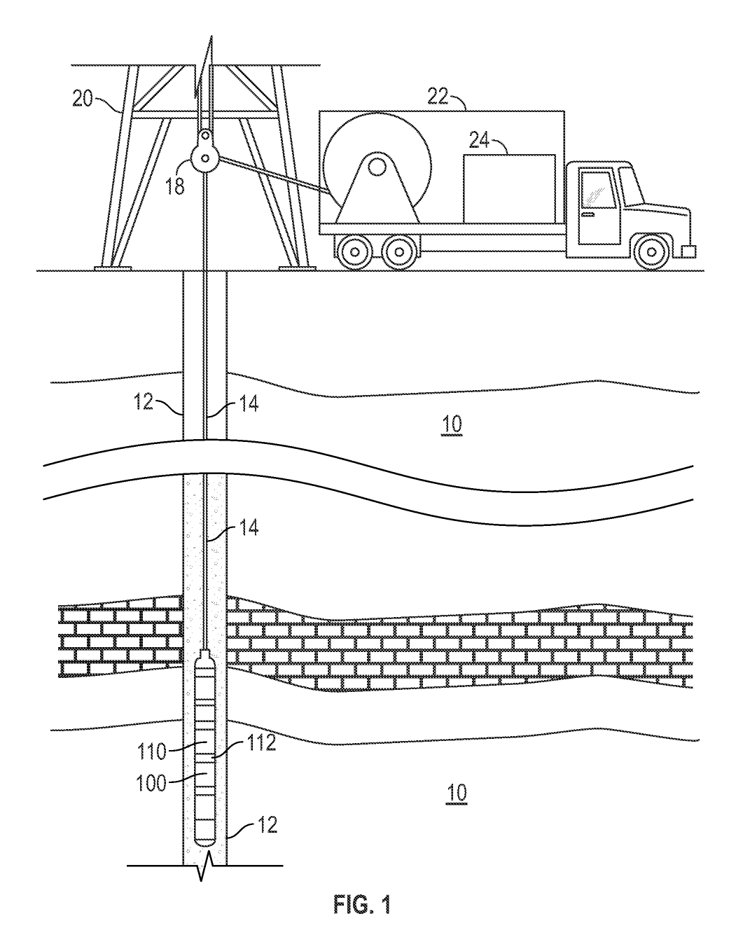

Referring initially to FIG. 1, there is schematically represented a cross-section of a subterranean formation 10 in which is drilled a borehole 12. Suspended within the borehole 12 at the bottom end of a carrier 14, such as a wireline, is a downhole assembly 100. In some embodiments, the carrier 14 may be rigid, such as a coiled tube, casing, liners, drill pipe, etc. In other embodiments, the carrier 14 may be non-rigid, such as wirelines, wireline sondes, slickline sondes, e-lines, drop tools, self-propelled tractors, etc. The term “carrier” as used herein means any device, device component, combination of devices, media and/or member that may be used to convey, house, support, or otherwise facilitate the use of another device, device component, combination of devices, media and/or member. The carrier 14 is often carried over a pulley 18 supported by a derrick 20. Wireline deployment and retrieval is performed by a powered winch carried by a service truck 22, for example. A control panel 24 interconnected to the downhole assembly 100 through the carrier 14 by conventional means controls transmission of electrical power, data/command signals, and also provides control over operation of the components in the downhole assembly 100. The data may be transmitted in analog or digital form. Downhole assembly 100 may include a fluid analysis module 112. Downhole assembly 100 may also include a sampling device 110. Herein, the downhole assembly 100 may be used in a drilling system (not shown) as well as a wireline. While a wireline conveyance system has been shown, it should be understood that embodiments of the present disclosure may be utilized in connection with tools conveyed via rigid carriers (e.g., jointed tubular or coiled tubing) as well as non-rigid carriers (e.g., wireline, slickline, e-line, etc.). Some embodiments of the present disclosure may be deployed along with Logging While Drilling/Measurement While Drilling tools. In some embodiments, the device may be configured for installation in a borehole 12.

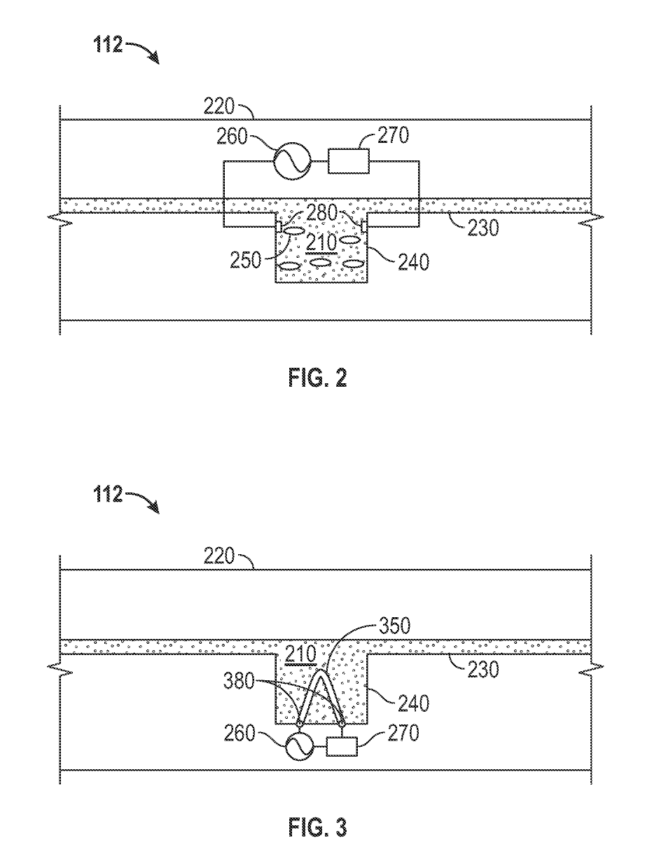

FIG. 2 shows an exemplary embodiment for a fluid analysis module 112 for testing one or more downhole fluids. Fluid analysis module 112 may include a housing 220 with a channel 230 configured to allow a fluid 210 to enter a chamber 240. The fluid 210 may include, but is not limited to, one of: (i) a drilling fluid, (ii) a formation fluid, (iii) a production fluid, and combinations thereof. The fluid 210 in chamber 240 may include one or more nano elements 250 configured to be suspended in the fluid 210. The fluid analysis module 112 may also include a power supply 260 and a processor 270 configured to estimate an impedance across a pair of electrodes 280 positioned to transmit and receive an electric current across at least part of chamber 240. Processor 270 may include an impedance analyzer. In some embodiments, the power supply 260 may be configured to supply AC power. The AC power may include one or more types of waveforms including, but not limited to, one or more of: (i) sinusoidal, (ii) square, (iii) triangular, and (iv) impulse. In some embodiments, the power supply 260 may include a waveform function generator. In some embodiments, at least one of the nano elements 250 may include at least one carbon nanotube. In some embodiments, nano elements 250 may include one or more of: (i) a graphene, (ii) carbon, (iii) nickel, (iv) gold, (v) silicon, and (vi) diamond. In some embodiments, fluid 210 may be a downhole fluid from the borehole 12. In some embodiments, passage of the at least one nano element 250 out of the chamber 240 may be prevented by screens (not shown) dimensioned to allow the passage of the fluid 210 into and out of the chamber 240 but not passage of the at least one nano element 250.

FIG. 3 shows another embodiment for the fluid analysis module 112. In this embodiment, fluid analysis module 112 may include housing 220 with a channel 230 configured to allow a fluid 210 to enter a chamber 240. Nano element 350 may be coupled to electrical leads 380 extending from at least one wall of chamber 240. The electrical leads 380 may be electrically coupled to power supply 260 and processor 270. Nano element 350 may be suspended in fluid 210. In some embodiments, at least one of the nano elements 350 may include at least one carbon nanotube. The at least one nano element 350 may include a physical characteristic of being resilient, rigid, or flexible. In embodiments that include a plurality of nano elements, the plurality of nano elements may include a combination of physical characteristics.

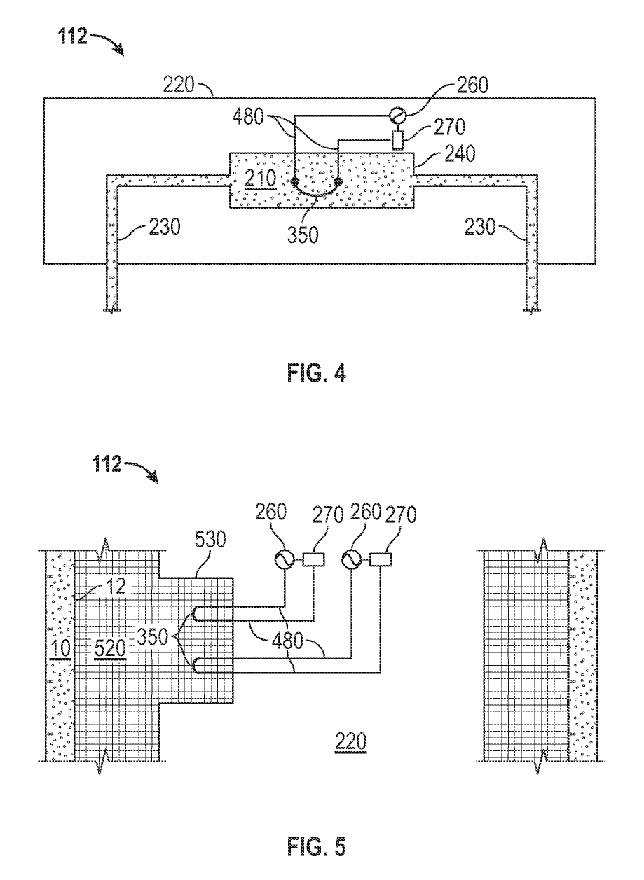

FIG. 4 shows another embodiment for the fluid analysis module 112. This embodiment includes nano element 350 suspended in fluid 210 between two conductors 480. In some embodiments, nano element 350 may hang between the conductors 480 in a shallow curve (such as a catenary). In some embodiments, nano element 350 may be held taught between the conductors 480. In some embodiments, nano element 350 may be stretched between the conductors 480.

FIG. 5 shows another embodiment for the fluid analysis module 112. In this embodiment, at least one nano element 350 may be exposed to a fluid 520 in the space between housing 220 and borehole wall 12. The fluid 520 may include, but is not limited to, one of: (i) a drilling fluid, (ii) a formation fluid, (iii) a production fluid, and combinations thereof. The conductors 480 and the at least one nano element 350 may be positioned in a recessed potion 530 of housing 220 configured to protect the at least one nano element 350 from damage due to impact with the borehole wall 12. In another embodiment, a first nano element 350 may be exposed to fluid 520 while a second nano element 350 may be isolated from fluid 520, such that the second nano element 350 may be used to estimate reference information under ambient conditions in the borehole 12. The reference information may include impedance information.

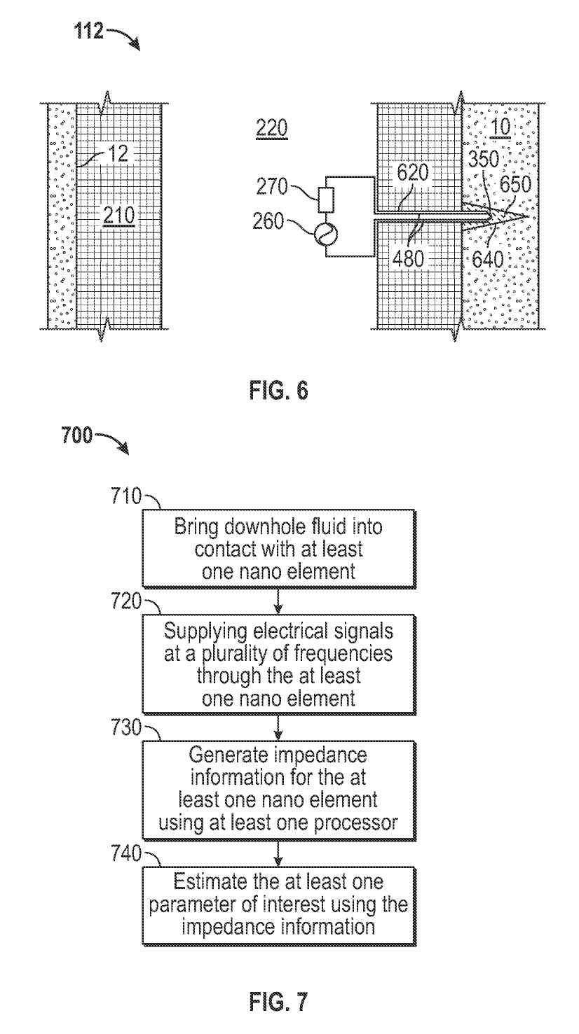

FIG. 6 shows another embodiment for the fluid analysis module 112. The at least one nano element 350 may be positioned in a fracture 640 in earth formation 10. A probe 620 may be configured to be extended from housing 220 into the earth formation 10. Probe 620 may also be configured to be retracted to housing 220. The at least one nano element 350 may be in contact with formation fluid 650 and coupled to conductors 480. The conductors 480 may run from power supply 260 and processor 270 to the at least one nano element 350 through probe 620.

In some embodiments, the at least one nano element 250, 350 may include a plurality of nano elements that may form a larger structure, such as a matrix of nano elements. In some embodiments, the larger structure may have a smallest dimension on the order of one nanometer to one millimeter. In other embodiments, the smallest dimension of the larger structure may exceed one millimeter.

FIG. 7 shows a flow chart of a method 700 for estimating a parameter of interest based of a downhole fluid 210, 520, 650 using embodiments of the fluid analysis module 112. In step 710, the downhole fluid 210, 520, 650 may be placed in contact with the surface of a nano element 250, 350. In step 720, electrical signals may be passed through at least one nano element 250, 350 using a plurality of different frequencies. In some embodiments, the electrical signals may be generated by power source 260. In step 730, a processor 270 may generate information indicative of the impedance of the at least one nano element 250, 350. In some embodiments, the processor 270 may include an impedance analyzer. In step 740, the at least one parameter of interest may be estimated using the impedance information. The at least one parameter of interest may include, but is not limited to, at least one of: chemical composition, density, thermal conductivity, electrical conductivity, electrical capacitance, temperature, pressure, flow velocity, magnetic permeability, and electrical permittivity. The estimation of the at least one parameter of interest may include using a characteristic frequency of a substance in the downhole fluid or the downhole fluid as a whole.

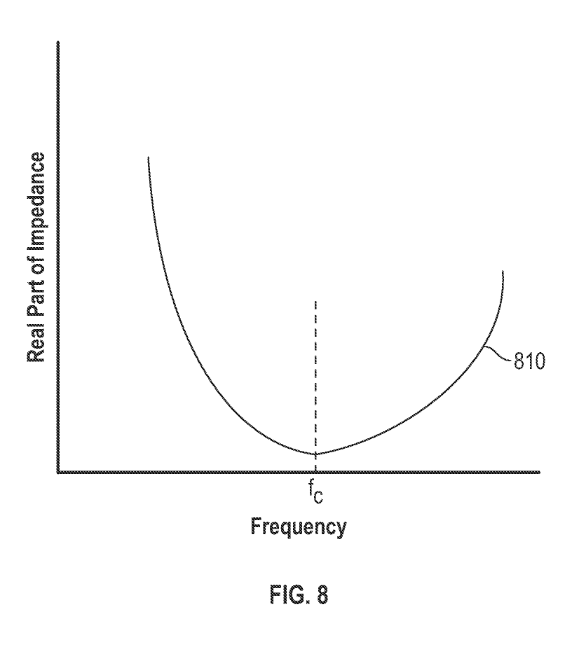

FIG. 8 shows a graph of an impedance estimated using the one embodiment of the present disclosure. Curve 810 shows the relationship of a real part of complex impedance with frequency. At a characteristic frequency, f_{c}, the real part of the impedance may reach a minimum value, which may be used to characterize the downhole fluid 210, 520, 650. While the present teachings have been discussed in the context of hydrocarbon producing wells, it should be understood that the present teachings may be applied to geothermal wells, groundwater wells, subsea analysis, surface based sensing, etc. Also, the present teachings may be applied to downhole installations for wellbore fluid monitoring and surface-based fluid recovery and analysis.

While the foregoing disclosure is directed to the one mode embodiments of the disclosure, various modifications will be apparent to those skilled in the art. It is intended that all variations be embraced by the foregoing disclosure.

What is claimed is:

1. A method of estimating a parameter of interest of a downhole fluid, the method comprising:
estimating the parameter of interest based on an impedance of at least one nano element using a processor, the at least one nano element being in contact with the downhole fluid and responsive to a plurality of frequencies.

2. The method of claim 1, further comprising:
applying an AC voltage to the at least one nano element.

3. The method of claim 2, wherein the AC voltage is applied over the plurality of frequencies:

4. The method of claim 2, wherein the AC voltage is applied one of: (i) momentarily in a transient manner and (ii) continuously.

5. The method of claim 1, wherein the processor includes an impedance analyzer.

6. The method of claim 1, wherein the parameter of interest includes at least one of: chemical composition, density, thermal conductivity, electrical conductivity, electrical capacitance, temperature, pressure, flow velocity, magnetic permeability, and electrical permittivity.

7. The method of claim 1, further comprising:
comparing the impedance with reference impedance information.

8. The method of claim 7, further comprising:
estimating the reference impedance information using at least one additional nano element.

9. The method of claim 1, wherein the at least one nano element includes at least one of: (i) a nano particle, (ii) a nano fiber, (iii) a nano wire, (iv) a nano thin film, and (v) a nanotube.

10. The method of claim 1, wherein the at least one nano element includes at least one of: (i) a graphene, (ii) carbon, (iii) nickel, (iv) gold, (v) silicon, and (vi) diamond.

11. The method of claim 1, wherein the downhole fluid includes at least one hydrocarbon.

12. An apparatus for estimating at least one parameter of a downhole fluid, the apparatus comprising:
at least one nano element configured to be in contact with the downhole fluid; and
a processor configured to estimate the impedance of the at least one nano element over a plurality of frequencies.

13. The apparatus of claim 12, further comprising:
a power source configured to supply AC voltage to the at least one nano element.

14. The apparatus of claim 13, wherein the AC voltage is supplied over the plurality of frequencies:

15. The apparatus of claim 12, further comprising:
at least one additional nano element configured to estimate reference impedance information.

16. The apparatus of claim 12, wherein the processor includes an impedance analyzer.

17. The apparatus of claim 12, wherein the parameter of interest includes at least one of:
chemical composition, density, thermal conductivity, electrical conductivity, electrical capacitance, temperature, pressure, flow velocity, magnetic permeability, and electrical permittivity.

18. The apparatus of claim 12, wherein the at least one nano element includes at least one of: (i) a nano particle, (ii) a nano fiber, (iii) a nano wire, (iv) a nano thin film, and (v) a nanotube.

19. The apparatus of claim 12, wherein the at least one nano element includes at least one of: (i) a graphene, (ii) carbon, (iii) nickel, (iv) gold, (v) silicon, and (vi) diamond.

20. The apparatus of claim 12, further comprising:
a nonconductive structure configured to structurally support at least one of the at least one nano element.

21. The apparatus of claim 12, wherein the downhole fluid includes at least one hydrocarbon.
